(19) United States
(12) Patent Application Publication
(10) Pub. No.: US 2022/0115917 A1
(43) Pub. Date: Apr. 14, 2022

(54) OBJECT DETECTION FOR WIRELESS CHARGING SYSTEM

(71) Applicants: Hyundai Motor Company, Seoul (KR); Kia Corporation, Seoul (KR)

(72) Inventor: Rakan Chabaan, Farmington Hills, MI (US)

(21) Appl. No.: 17/558,895

(22) Filed: Dec. 22, 2021

Related U.S. Application Data
(62) Division of application No. 16/795,679, filed on Feb. 20, 2020.

(51) Int. Cl. H02J 50/60; G01V 3/10; H02J 50/12

(52) U.S. Cl. CPC H02J 50/60; H02J 50/12; G01V 3/10

(57) ABSTRACT

An object detection system for a wireless power transfer system is provided. The systems detect foreign objects such as metal objects between a receiver pad and a transmission pad of the wireless power transfer system. The systems utilize various configurations of detection coils to prevent blind spots and ensure efficiency. The systems utilize various circuits to amplify signals generated by the systems and ensure accuracy. The systems prevent hazards associated with magnetic inductive power transfer.

### TECHNICAL FIELD

The present disclosure relates to an object detection for a wireless charging system, and more particularly, to an inductive wireless power transfer system in which an object on a transmission pad is detected.

### BACKGROUND

With the development of electric and hybrid vehicles, charging system development is also increasing. Wireless power transfer for charging applications uses a magnetic field to transfer the power wirelessly. In order to apply such wireless power transfer for wireless charging of electric vehicles, the magnetic field is required to be strong. That is, a substantial amount of energy is required to transfer power for wireless charging for vehicles.

Known wireless charging systems utilize a ferrite plate and an aluminum plate for the charging pads to provide such a strong magnetic field while mitigating the magnetic field outside the charging pads. However, if a metal object, such as a key, paperclip, coin, or tinfoil falls between the charging pads during power transfer, an eddy current is generated in the metal object which causes overheating of the object and its surrounding medium. Additionally, the strong magnetic field between the charging pads may be harmful to animals, especially in a wireless charging system for electric vehicles where the charging distance is substantial enough for an animal, such as a cat or a dog to be within the charging space.

Various technologies have been developed for detecting the presence of an object between charging pads. For example, when a metal object is placed in a charging area of a wireless power transfer system, variation is detected in efficiency, output power, currents on transmitter and receiver coils, quality factors of the transmitter and receiver coils, as well as other system parameters. Thus, the variation in system parameters is used to detect the object. However, such a technology is not applicable for high-power applications such as wireless charging of electric vehicles. Additionally, misalignment between the transmitter and receiver coils may occur thus affecting system parameters and providing an incorrect indication of an object.

Another developed technology uses sensors to detect the object in the wireless power transfer area. For example, thermistor sensors, thermal cameras, radar sensors, and ultrasonic sensors have been used to detect objects. Other systems use temperature sensors to detect the temperature increase in the object due to the eddy current generation. However, the addition of sensors further increases the overall system costs.

Therefore, a technology development is required for improving the detection of objects in the area of a wireless power transfer.

### SUMMARY

The present disclosure provides an inductive wireless power transfer system in which the presence of an object on a transmission pad is detected to prevent eddy currents, overheating of the object and surrounding structures, fire hazards, and harm to animals such as pets who may unwittingly place themselves into the electromagnetic field of the power transfer system.

In an exemplary embodiment, an inductive wireless power transfer system is provided. The inductive wireless power transfer system may include a receiver pad, a transmission pad, and a detection coil layer disposed on the transmission pad to detect an object disposed thereon. The transmission pad may be configured to generate an electromagnetic field to provide energy transfer to the receiver pad.

In an exemplary embodiment, the detection coil layer may include multi-layer detection coils and each multi-layer detection coil may include a particular number of detection coils. Each detection coil may include an inductor provided in series with a resistor. The detection coil layer may be a single layer that includes a plurality of detection coil sets and each detection coil set may include two detection coils connected in series with opposite polarities. The detection coil layer may be a four-layer coil pattern. Individual detection coils of the detection coil layer may overlap to eliminate a gap between each detection coil. A cover may be disposed on the detection coil layer.

In an exemplary embodiment, a processor may be configured to detect a change in impedances of the detection coils to detect the object disposed on the detection coil layer. The processor may be configured to convert the change in impedances to an output voltage signal through a resonant circuit and a signal processing circuit. To confirm presence of the object, the processor may be configured to determine a difference between an impedance when no object is disposed on the detection coil layer and an impedance when the object is disposed on the detection coil layer to be greater than a predetermined threshold.

In an exemplary embodiment, the inductive wireless power transfer system may include a resonant circuit. The resonant circuit may include a first capacitor connected in series to a detection coil of the detection coil layer and a second capacitor connected in parallel to the detection coil.

In an exemplary embodiment, the inductive wireless power transfer system may include a first resonant tank having at least one capacitor configured to resonate with a transmitter coil of the transmission pad. The inductive wireless power transfer system may include a second resonant tank having at least one capacitor configured to resonate with a receiver coil of the receiver pad. The transmitter coil may include a plurality of detection coils. The inductive wireless power transfer system may include a plurality of switches corresponding to the plurality of detection coils and configured to selectively couple each detection coil.

In another exemplary embodiment, a system for detecting an object in a wireless power transfer system is provided. The system may include a resonant circuit configured to receive an input voltage signal. The resonant circuit may include a detection coil array and a first capacitor connected in series to the detection coil array and a second capacitor connected in parallel to the detection coil array. The system may include a voltage follower connected to the resonant circuit and configured to isolate the input voltage signal in response to receiving the input voltage signal from the resonant circuit. The system may include a filter connected to the voltage follower and configured to filter and amplify the input voltage signal in response to receiving the input voltage signal from the voltage follower. The system may include a rectifier connected to the filter and configured to rectify the input voltage signal in response to receiving the input voltage signal from the filter and to output a voltage indicative of an object presence.

The detection coil array may include a plurality of detection coil sets and each detection coil set may include two detection coils connected in series with opposite polarities. The detection coil array may include multi-layer detection coils and each detection coil may include an inductor provided in series with a resistor.

Notably, the present disclosure is not limited to the combination of the elements as listed above and may be assembled in any combination of the elements as described herein. Other aspects of the disclosure are disclosed infra.

### BRIEF DESCRIPTION OF THE DRAWINGS

A brief description of each drawing is provided to more sufficiently understand drawings used in the detailed description of the present disclosure.

FIG. 1 is a side view and a schematic representation of an object detection system according to an exemplary embodiment of the present disclosure;

FIG. 2 is a plan view of a detection coil pattern according to an exemplary embodiment of the present disclosure;

FIG. 3 is a plan view of a layer of detection coils according to an exemplary embodiment of the present disclosure;

FIG. 4 is a plan view of multi-layer overlapped detection coils according to an exemplary embodiment of the present disclosure;

FIG. 5 is a side view of multi-layer horizontally and vertically overlapped detection coils according to an exemplary embodiment of the present disclosure;

FIG. 6A is a perspective view of a model of a detection coil according to an exemplary embodiment of the present disclosure;

FIG. 6B is an equivalent circuit diagram of a detection coil according to an exemplary embodiment of the present disclosure;

FIG. 6C is an equivalent circuit diagram of an equivalent circuit model according to an exemplary embodiment of the present disclosure;

FIG. 7 is an equivalent circuit diagram of a resonant circuit according to an exemplary embodiment of the present disclosure;

FIG. 8 is an equivalent circuit diagram of a wireless power transfer system according to an exemplary embodiment of the present disclosure; and

FIG. 9 is an overall circuit configuration of an object detection system according to an exemplary embodiment of the present disclosure.

It should be understood that the above-referenced drawings are not necessarily to scale, presenting a somewhat simplified representation of various features illustrative of the basic principles of the disclosure. The specific design features of the present disclosure, including, for example, specific dimensions, orientations, locations, and shapes, will be determined in part by the particular intended application and use environment.

### DETAILED DESCRIPTION

Advantages and features of the present disclosure and a method of achieving the same will become apparent with reference to the accompanying drawings and exemplary embodiments described below in detail. However, the present disclosure is not limited to the exemplary embodiments described herein and may be embodied in variations and modifications. The exemplary embodiments are provided merely to allow one of ordinary skill in the art to understand the scope of the present disclosure, which will be defined by the scope of the claims. Accordingly, in some embodiments, well-known operations of a process, well-known structures, and well-known technologies will not be described in detail to avoid obscure understanding of the present disclosure. Throughout the specification, same reference numerals refer to same elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Although an exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The present disclosure generally provides systems for detecting foreign objects during wireless power transfer. In an exemplary embodiment, an inductive wireless power transfer system includes a receiver pad, a transmission pad, and a detection coil layer disposed on the transmission pad to detect an object disposed thereon. The transmission pad generates an electromagnetic field to provide energy transfer to the receiver pad. To detect the object, which may interfere with the energy transfer, the system is configured to detect changes in attributes (e.g., impedance, inductance, resistance, and the like) of an electrical current flowing through parts of the system.

In use, the inductive wireless power transfer system detects foreign objects such as metal objects between the receiver pad and the transmission pad. The system may be configured to send a signal limiting or stopping power transfer in response to detection of a foreign object. Thus, the system reduces the risk of eddy currents due to the presence of such metal objects and reduces the risk of overheating, fire, and the like. The system is suitable for use with high-power applications, avoids the need for relatively high-cost items such as sensors, and promotes overall system efficiency and accuracy. Also, the system may reduce a risk of blind spots in performing foreign object detection.

A person skilled in the art will appreciate that, while systems are disclosed herein for detecting foreign objects for wireless charging systems, the systems can be used in a variety of other wireless systems.

In one exemplary embodiment, a metal object detection system includes a detection coil and a resonant circuit. An impedance in the detection coil changes in response to the presence of a foreign object.

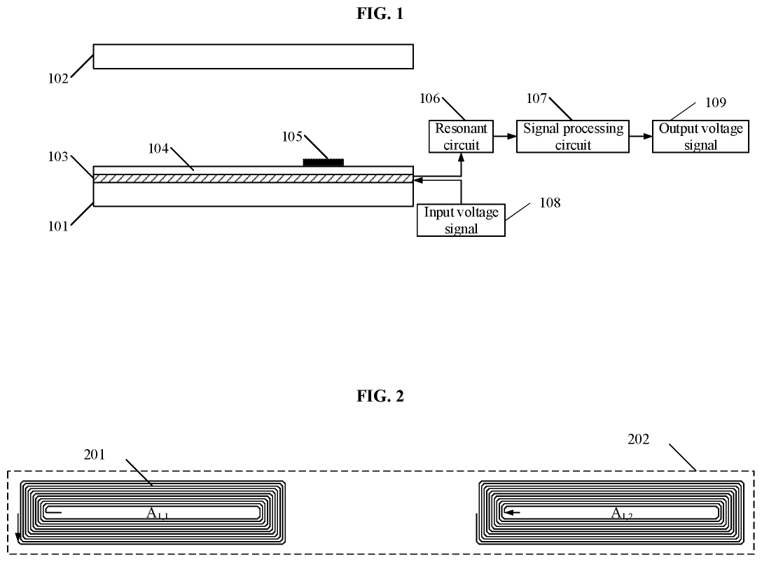

FIG. 1 illustrates an exemplary embodiment of a foreign object detection system for a wireless power transfer system. The left side of FIG. 1 is a side view of the system, and the right side of FIG. 1 is a schematic view of components of the system. As shown, in a state where a foreign object such as a metal object 105 becomes located between a transmission pad 101 and a receiver pad 102 of a wireless power transfer system, a temperature of the metal object 105 will be relatively high, and the presence of the metal object 105 may negatively affect an efficiency of power transfer between the transmission pad 101 and the receiver pad 102. A detection coil pattern 103 may be provided on the transmission pad 101, and a plastic cover plate 104 may be used to protect the detection coil pattern 103 and the transmission pad 101. In a condition where the metal object 105 becomes located over the detection coil pattern 103, an impedance of the detection coil pattern 103 changes. In this condition, the metal object 105 may be in direct physical contact with the plastic cover plate 104 and over the detection coil pattern 103. An input voltage signal 108 may be provided to the detection coil pattern 103. The change in the impedance due to the presence of the metal object 105 may be converted to a change in an output voltage signal 109 (relative to the input voltage signal 108) through a resonant circuit 106 and a signal processing circuit 107. Thus, the presence of the metal object 105 is detected and risks of safety hazards caused by the metal object 105 are reduced. In the illustrated exemplary embodiment of FIG. 1, the detection coil 103 and the resonant circuit 106 are provided. As will be discussed in more detail below, the system may include multiple detection coils in various configurations, and one or more electrical circuits in various configurations.

The detection coil may have a variety of configurations, shapes, and sizes. In another exemplary embodiment, multi-layer detection coils may be provided. The multi-layer detection coils may utilize induced voltage and a bipolar coil.

FIG. 2 illustrates a plan view of an exemplary embodiment of multi-layer detection coils for a foreign object detection system for a wireless power transfer system. As shown, the detection coil pattern 103 consists of multi-layer detection coils. Each layer of the detection coils may be composed of a certain number of individual detection coils 201. Two individual detection coils are shown in FIG. 2, though any suitable number may be provided. The individual detection coils 201 may have a shape in plan view that is rectangular or square. When the individual detection coil 201 is placed on the transmission pad 101 (in lieu of the detection coil pattern 103), there will be induced voltage in individual detection coils 201. The induced voltage in the individual detection coils 201 may be canceled out. A bipolar coil achieves decoupling with a main unipolar coil and can cancel out the induced voltage. Two adjacent individual detection coils A_{1,1} and A_{1,2} are connected in series with opposite polarities to form a detection coil set 202. The arrow adjacent to the individual detection coils A_{1,1} indicates counter-clockwise direction of flow. The arrow adjacent to the individual detection coils A_{1,2} indicates clockwise direction of flow. These directions of flow may be reversed so long as they are opposite each other.

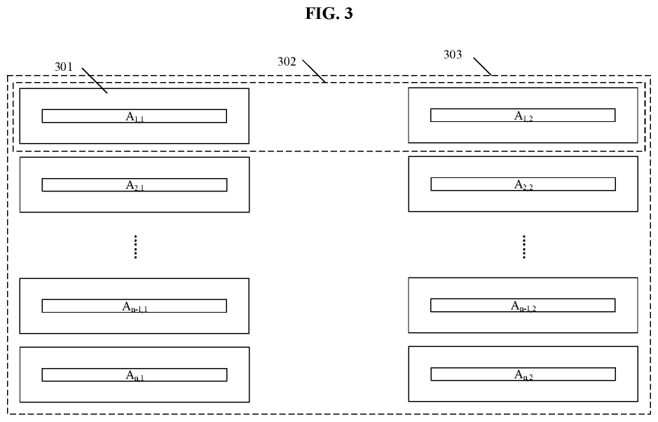

FIG. 3 illustrates a plan view of an exemplary embodiment of an array or a layer of multi-layer detection coils for a foreign object detection system for a wireless power transfer system. As shown, one-layer detection coils 303 consists of n detection coil sets 302. Each of the detection coil sets 302 may be similar to detection coil set 202 shown in FIG. 2. The individual detection coils A_{2,1} and A_{2,2} may be connected in series with opposite polarities, and the individual detection coils A_{n,1} and A_{n,2} may be connected in series with opposite polarities. In between the individual detection coils A_{2,1} and A_{2,2} and the individual detection coils A_{n,1} and A_{n,2}, one or more individual detection coils A_{n-1,1} and A_{n-1,2} may be provided.

Gaps may be provided between the individual detection coils 301 of the one-layer detection coils 303. In addition, at an edge of the individual detection coils 301, the impedance variation of the individual detection coils 301 caused by the metal object may be relatively small. Therefore, the metal object cannot be detected at the gap between the individual detection coils 301 of the one-layer detection coils 303, nor at the edge of the individual detection coils 301. If the metal object is on or over the detection coil pattern 103 but cannot be detected (for instance, because the metal object is located on the above-described gap or the edge), such positions on the detection coil pattern 103 may be referred to as blind spots. The one-layer detection coils 303 can eliminate many blind spots. Additional configurations, described below, may more completely eliminate blind spots.

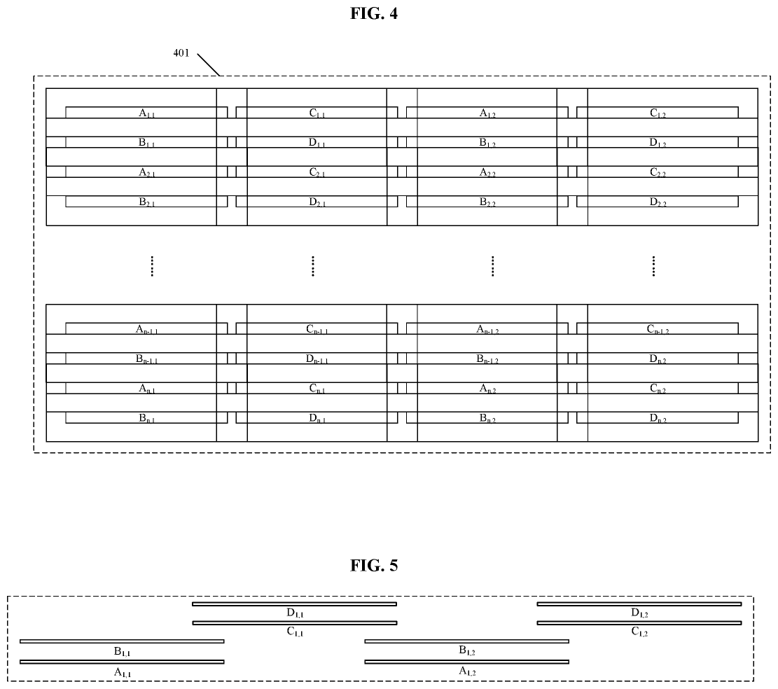

FIG. 4 illustrates a plan view of an exemplary embodiment of 4-layers of overlapped multi-layer detection coils for a foreign object detection system for a wireless power transfer system. As shown, 4-layer detection coils form a detection coil pattern 401. The detection coil pattern 401 is used to cover the transmission coil without blind spots. Detection coils A, B, C and D belong to the 4-layer detection coils, respectively. The gap between the individual detection coils of the one-layer structure and the edge of the individual detection coil of another one-layer structure may be covered by the detection coils of the other layers. Therefore, the blind spots may be eliminated.

Please note, FIG. 4 illustrates a 4×4 array of overlapped detection coils repeating up to an n×4 array of overlapped detection coils. That is, as shown, a first segment of coils includes coils A_{1,1} and A_{1,2} in a same row as coils C_{1,1} and C_{1,2}; coils A_{1,1} and A_{2,1} in a same column as coils B_{1,1} and B_{2,1}; coils B_{1,1} and B_{1,2} in a same row as coils D_{1,1} and D_{1,2}; coils C_{1,1} and C_{2,1} in a same column as coils D_{1,1} and D_{2,1}; coils A_{2,1} and A_{2,2} in a same row as coils C_{2,1} and C_{2,2}; coils A_{1,2} and A_{2,2} in a same column as coils B_{1,2} and B_{2,2}; coils B_{2,1} and B_{2,2} in a same row as coils D_{2,1} and D_{2,2}; coils C_{1,2} and C_{2,2} in a same column as coils D_{1,2} and D_{2,2}. An n-th segment of coils may have the same configuration as the first segment of coils. One or more segments of coils may be provided between the first segment and the n-th segment. However, it is understood that any suitable array may be provided. There may be any suitable number of rows and columns and any suitable number of repeating segments.

FIG. 5 illustrates a side view of an exemplary embodiment of overlapped multi-layer detection coils for a foreign object detection system for a wireless power transfer system. As shown, a 4-layer printed circuit board with overlapped layers of detection coils is used to implement the overlapped 4-layer detection coil pattern 401 of FIG. 4. The gap between the individual detection coils 301 of the one-layer detection coil is used for wiring and routing of another layer. That is, in addition to the overlapping shown in FIG. 4 and described above, the coil pattern may have overlapping elements in any suitable configuration.

As shown in FIG. 5, coils A_{1,1} are completely vertically overlapped with coils B_{1,1}; coils A_{1,2} are completely vertically overlapped with coils B_{1,2}; coils C_{1,1} are completely vertically overlapped with coils D_{1,1}; and coils C_{1,2} are completely vertically overlapped with coils D_{1,2}. Also, a first portion of coils A_{1,1} and B_{1,1} are vertically overlapped with a first portion of coils C_{1,1} and D_{1,1}; a second portion of coils C_{1,1} and D_{1,1} are vertically overlapped with a first portion of coils A_{1,2} and B_{1,2}; and a second portion of coils A_{1,2} and B_{1,2} are vertically overlapped with a first portion of coils D_{1,2} and C_{1,2}. However, it is understood that any suitable array may be provided. There may be any suitable number of overlapping portions, and the extent and orientation of overlap between groups of coils may vary in any suitable configuration.

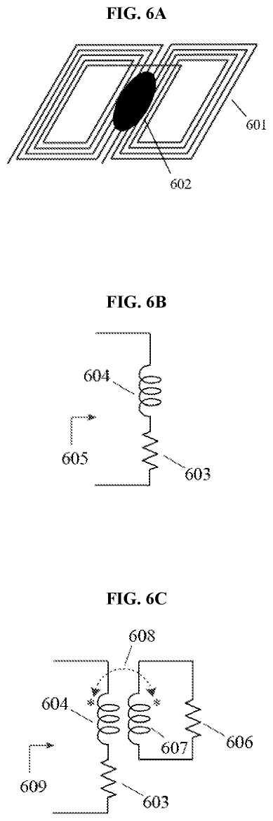

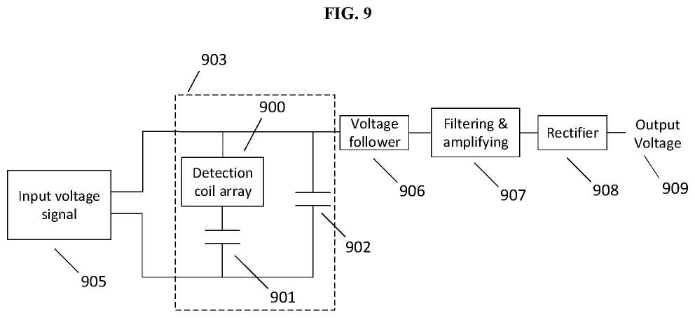

Having described above various physical configurations for the detection coils, the system may include various equivalent circuits for detection of the foreign object. Equivalent circuits of various exemplary embodiments are provided in FIGS. 6, 7 and 8. FIG. 9 illustrates an exemplary embodiment of an overall circuit configuration of a foreign object detection system.

FIG. 6A shows a model of a detection coil 601 with a foreign object 602. An equivalent circuit of the detection coil 601 may be regarded as an inductor 604 in series with a resistor 603, as shown in FIG. 6B. The equivalent circuit model under the influence of the foreign object 602, which may be a metal object, around the detection coil 601 based on a mutual coupling model is shown in FIG. 6C. The foreign object 602 may be regarded as an inductor 607 in series with a resistor 607. When there is no a metal object in the vicinity of a wireless power transfer system, an input impedance 605 of the detection coil may be expressed as Equation (1), as follows:

$$\text{?} \\ \text{?} \text{indicates text missing or illegible when filed} \qquad ( 1 )$$

In Equation (1), Zᵢₙ is the input impedance 605, R_{det-i} is a resistance of the resistor 603 of the detection coil 601, j is an imaginary constant, and L_{det-i} is an inductance of the inductor 604 of the detection coil 601.

When a metal object is placed on the charging area, an input impedance 609 of the detection coil may be expressed as Equation (2), as follows:

$$\text{?} \\ \text{?} \text{indicates text missing or illegible when filed} \qquad ( 2 )$$

In Equation (2), Zᵢₙ is the input impedance 609, R_{det-i} is the resistance of the resistor 603 of the detection coil 601, ω is angular frequency, R_{MO} is a resistance of a metal object (MO), L_{MO} is an inductance of the metal object (MO), j is the imaginary constant, and L_{det-i} is the inductance of the inductor 604 of the detection coil 601.

A comparison system declares a presence of a foreign object in proximity to the charging area of a wireless power transfer system in response to a difference 608 between input impedance 605 and input impedance 609 exceeding a threshold value.

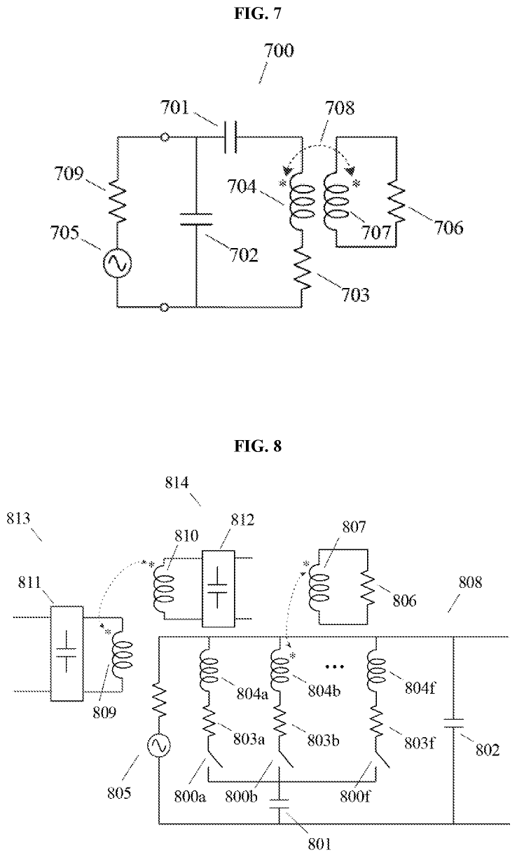

Even though there is a change on input impedance of the detection coil due to the existence of the metal object, the variation itself is relatively small and measurement may be difficult without amplification. In some embodiments, a resonant circuit 700 may be applied to the detection coil to amplify the impedance variation. An equivalent circuit of an exemplary embodiment of the resonant circuit 700 is shown in FIG. 7. A series connected capacitor 701 and a parallel connected capacitor 702 resonate together with a detection coil 704. A voltage source 705 and a resistor 709 may be provided in series, and the series connected voltage source 705 and resistor 709 may be connected in parallel with the parallel connected capacitor 702. The right side of FIG. 7 is similar to FIG. 6C; therefore, like reference numerals and descriptions of like structures are omitted herein for brevity.

As shown in FIG. 8, in an exemplary embodiment, a wireless power transfer system 813 including a foreign object detection system 808 is provided. The inductive wireless power transfer system may include a wireless power transmitting coil 809 of a transmitting unit 813, and a wireless power receiving coil 810 of a receiving unit 814. In the transmitting unit 813, the transmitting coil 809 may be configured to generate an electromagnetic field for providing energy transfer to the receiving coil 810. Also in the transmitting unit 813, a resonant tank 811 including one or more capacitors may be configured to resonate with the transmitting coil 809. In the receiving unit 814, a resonant tank 812 including one or more capacitors may be configured to resonate with the receiving coil 810.

To increase the detection sensitivity to a relatively small metal object, for example coins or paper clips, multiple detection coils 804a, 804b . . . 804f may be provided in the transmitting side of the wireless power transfer system. A plurality of respective switches or multiplexers 800a, 800b . . . 800f may be configured to selectively couple each of the detection coils. Although three detection coils are illustrated in FIG. 8, any suitable number may be provided. For example, in some embodiments, 50, 60 or 70 detection coils may be provided similar to detection coils 804a, 804b . . . 804f The upper right side of FIG. 8 is similar to FIG. 6C and the right side of FIG. 7, and the lower right side of FIG. 8 is similar to the left side of FIG. 7; therefore, like reference numerals and descriptions of like structures are omitted herein for brevity.

FIG. 9 illustrates an overall circuit configuration of a foreign object detection system according to an exemplary embodiment. A foreign object such as the metal object 105 can cause a decrease in the inductance of the detection coil and an increase in resistance. The impedance change may be converted by a resonant circuit 903 into a change in the voltage signal and amplified, as shown, for example, in FIGS. 7 and 8. The resonant circuit 903 may be configured to receive an input voltage signal 905. An output voltage 909 of the resonant circuit 903 may be isolated by a voltage follower 906, filtered and amplified by high pass and band-pass filters 907, and rectified by a precision rectifier 908. Then, the output voltage 909 of the rectifier 908 may be used to indicate the presence of the foreign object.

The detection systems of the various disclosed embodiments and their equivalents promote the development of wireless power transfer via magnetic induction. Each of the exemplary systems described above, such as those shown in FIGS. 1 and 9, including the exemplary detection coils shown in FIGS. 2, 3, 4, 5 and 6A, and including the exemplary circuits shown in FIGS. 6B, 6C, 7 and 8, is configured to detect foreign objects such as metal objects between a receiver pad and a transmission pad of a wireless power transfer system. The object detection system may be configured to send a signal limiting or stopping power transfer of the wireless power transfer system in response to detection of a foreign object. In use, the object detection system reduces the risk of eddy currents, reduces the risk of overheating, fire, and the like, is suitable for use with relatively high-power applications, avoids the need for relatively high-cost items such as sensors, promotes overall system efficiency, and reduces the risk of blind spots.

Hereinabove, although the present disclosure is described by specific matters such as concrete components, and the like, the exemplary embodiments, and drawings, they are provided merely for assisting in the entire understanding of the present disclosure. Therefore, the present disclosure is not limited to the exemplary embodiment. Various modifications and changes may be made by those skilled in the art to which the disclosure pertains from this description. Therefore, the spirit of the present disclosure should not be limited to the above-described exemplary embodiments, and the following claims as well as all technical spirits modified equally or equivalently to the claims should be interpreted to fall within the scope and spirit of the disclosure.

1.-14. (canceled)

15. A system for detecting an object in a wireless power transfer system, comprising:
a resonant circuit configured to receive an input voltage signal, wherein the resonant circuit includes a detection coil array and a first capacitor connected in series to the detection coil array and a second capacitor connected in parallel to the detection coil array;
a voltage follower connected to the resonant circuit and configured to isolate the input voltage signal in response to receiving the input voltage signal from the resonant circuit;
a filter connected to the voltage follower and configured to filter and amplify the input voltage signal in response to receiving the input voltage signal from the voltage follower; and
a rectifier connected to the filter and configured to rectify the input voltage signal in response to receiving the input voltage signal from the filter and to output a voltage indicative of an object presence.

16. The system of claim 15, wherein the detection coil array includes a plurality of detection coil sets and each detection coil set includes two detection coils connected in series with opposite polarities.

17. The system of claim 15, wherein the detection coil array includes a multi-layer detection coils and each detection coil includes an inductor provided in series with a resistor.
